(19) United States
(12) Patent Application Publication
(10) Pub. No.: US 2006/0164618 A1
(43) Pub. Date: Jul. 27, 2006

(54) Method and apparatus for measurement of exit pupil telecentricity and source boresighting

(76) Inventors: Adlai H. Smith, Escondido, CA (US); Robert O. Hunter JR., Snowmass Village, CO (US)

Correspondence Address: HELLER EHRMAN LLP, 4350 LA JOLLA VILLAGE DRIVE #700, 7TH FLOOR, SAN DIEGO, CA, 92122, US

(21) Appl. No.: 11/340,084

(22) Filed: Jan. 26, 2006

Related U.S. Application Data
(60) Provisional application No. 60/647,615, filed on Jan. 26, 2005.

(51) Int. Cl. G03B 27/52

(52) U.S. Cl. 355/55; 355/52

(57) ABSTRACT

Exit pupil and source telecentricity of a projection imaging tool system is determined. The system contains a light source, an optical imager, a reticle, a substrate, and a positioner. The light source is optically coupled to the optical imager, the optical imager having an exit pupil. The combination of the light source and the optical imager define a projection imaging tool, are characterized by a partial coherence. The reticle has an array of patterns, each pattern having at least a first feature and a second feature. A substrate may be used to record at least a first image and a second image of the features. The positioner is used to dispose the first image and the second image such that the first image has a first defocus and the second image has a second defocus different from the first defocus. A processor is used to calculate the telecentricity based on an exit pupil and light source differential shift coefficient and positional offsets between features contained in the first image and features contained in the second image.

### REFERENCE TO PRIORITY DOCUMENT

This application claims priority benefit of U.S. Provisional Patent Application Ser. No. 60/647,615 filed Jan. 26, 2005 entitled “Method and Apparatus for Measurement of Exit Pupil Telecentricity and Source Boresighting” by Smith et al. Priority of the filing date of the prior application is hereby claimed, and the disclosure of the prior application is hereby incorporated by reference in its entirety.

### BACKGROUND

1. Field of the Invention

The present invention relates generally to the field of semiconductor manufacturing and more specifically to the measurement of telecentricity of a projection imaging tool used in photolithography.

2. Description of Related Art

Photolithography systems are commonly used in the manufacture of semiconductor devices. During fabrication, circuits are typically built one layer at a time by coating a substrate with a layer of photoresist and then exposing the photoresist to light transmitted through a mask containing the pattern to be etched onto the substrate. Depending on whether a positive or negative photoresist is used, portions of the photoresist layer that have either been exposed or not exposed are removed to expose the substrate. Finally, the exposed portions of the substrate are etched by various means.

One exposure configuration that has been used is to locate the mask on or near the photoresist layer. As the demand for ever higher circuit density has increased, the minimum feature size or critical dimension (CD) has become correspondingly smaller (with similar reductions in feature pitch). In order to accommodate this demand for smaller CD (low k1 manufacturing), a more preferred exposure configuration is to image the mask onto the photoresist layer using an optical imager to demagnify the mask features, typically by a factor of 4 or 5.

A projection imaging tool comprising an optical imager and associated light source is used to image the mask onto a photoresist surface. In order to provide an image having a small CD, the projection imaging tool should be nearly telecentric in order to reduce transverse shifts at defocused portions of the exposure field caused by unevenness in the substrate surface. A system is telecentric when light passing (principal rays) through the image plane of the optical imager is parallel to the optical axis (see, for example, Born et al., “Principles of Optics, 7^{th} Edition”, Cambridge University Press, p. 200, 2001). The magnification of a telecentric system remains constant so that points within an image maintain the same transverse coordinate over the depth of focus. This is important for modern scanners and stepper systems since (single and double) telecentric optical systems can better handle wafer/reticle non-flatness, wafer tilt, and system defocus (distortions or overlay error) since these variations will be somewhat mitigated.

One method for determining the telecentricity of a projection imaging tool is to record two or more images of a test mask onto a substrate located in a plane near the image plane. One of the images is recorded with the substrate located at one end of the depth of field, while the other is recorded at the opposite end (typically at approximately 500 nm from the best focus of the test mask image). Generally, the test mask is configured with an array of features containing a large box (also called alignment or overlay marks) and small box positioned a known distance d from the large box. Between the two recordings, the wafer is translated by the distance d/M so that, in the absence of any non-telecentricities or other optical aberrations, the substrate contains an array of images in which the smaller box is exactly centered in the larger box. The positional offset of the box-in-box images may be correlated to the degree of telecentricity of the projection imaging tool at that location within the image field.

One problem that arises with this method is that a positional offset of the box-in-box image may be produced by other system effects besides the exit pupil telecentricity. For instance, the source telecentricity or boresighting error may also produce a positional offset of the box-in-box image (FIG. 2). What is needed for accurate telecentricity measurements is a method of separating (decoupling) the lithographic effects (feature or positional shifts) of source telecentricity from exit pupil telecentricity—thus allowing independent determination of each.

Another factor that can influence telecentricity as determined by the aforementioned technique is lens aberrations, especially coma. These (odd) aberrations produce a shift in image position as a function of defocus. It would be desirable to separate the effects of lens aberration induced shift from telecentricity shift.

From the above discussion, it would be desirable to have a technique for determining both exit pupil telecentricity and source telecentricity especially when the stepper or scanner system suffers from unknown focus shifts or offsets. Additionally, and more importantly, since there are very few (if any) tools in the factory (semiconductor fab) that can rapidly and accurately measure the state of telecentricity of the exit pupil and light source on the factory floor—without disturbing day-to-day process operations to make complex optical measurements—the need for in-situ (telecentricity) monitors is critical.

### SUMMARY

Photolithography plays the vital role in semiconductor manufacturing of defining the ultimate features that are etched or deposited within each layer of the device. Projection imaging machines, usually of the stepper or scanner variety, using effective light sources that can be varied over a wide range of configurations perform this function. FIG. 1 shows a block diagram of a typical projection imaging system as would be found in a stepper or scanner. Effective source, ES, is responsible for generating and shaping the light incident on the reticle. It consists of a light source, LS, (typically an excimer laser operating at wavelengths of 248 nm or 193 nm), two blocks of beam shaping optics (IIO and OIO) that produce spatially and angularly uniform light incident on reticle R. Spatial uniformity requirement is simple; it must be constant across reticle R. Angular uniformity means the angular spectrum of radiation (dE/do(nxr,nyr)) needs to be the same at all field points (e.g., x,y transverse positions on R). As noted, both the source and exit pupil are never perfectly aligned either by design or other unknown optical problems leading to pattern distortion or telecentricity errors. FIG. 2 is a diagram providing definitions for telecentric imaging.

One aspect of determining exit pupil telecentricity involves a projection imaging tool system including a light source, an optical imager, a reticle, a substrate, and a positioner/stage (as described above). The light source may be optically coupled to the optical imager, the optical imager having an exit pupil (for a telecentric system—this should be located˜infinity—although in general this is not the case and overlay and distortion errors arise). The combination of the light source and the optical imager define a projection imaging tool that in the simplest, case is characterized by a partial coherence. For this work, the reticle (described in detail below) includes an array of patterns each pattern having at least a first feature and a second feature (for this work, these patterns will be in the form of alignment attributes or overlay patterns). The substrate covered with a suitable recording media (resist or electronic detector) may be used to record at least a first image and a second image of the features. The positioner or stage is used to dispose the first image and the second image such that the first image has a first defocus (Z) and the second image has a second defocus different from the first defocus. A processor (calculation) is used to calculate the exit pupil telecentricity based on an exit pupil differential shift coefficient and positional offsets between features contained in the first image and features contained in the second image (measured with a conventional overlay reader—see, for example, “KLA 5200 Overlay Brochure”, KLA-Tencor). A differential shift coefficient of the exit pupil may depend upon a light source partial coherence. The exit pupil differential shift coefficient may be, for example, approximately equal to −1. In addition, a source may be characterized by its differential shift coefficient. The source differential shift coefficient may be less than a differential shift coefficient of the exit pupil, for example the exit pupil differential shift coefficient may be approximately 5 times, or 10 times, greater than the source differential shift coefficient. In addition, the source differential shift coefficient may be approximately zero.

In another variation, a reticle with an in-situ z-monitor or focus structure and special phase-grating structures is combined with known aberrations and source structure (sigma settings) to determine both exit pupil and source telecentricity.

An embodiment of a method of determining telecentricity of an exit pupil in a projection imaging tool can include exposing an array of alignment attributes onto a substrate, wherein the exposure of alignment attributes is performed at a first focus position. Then exposing an array of complementary alignment attributes onto the substrate, wherein the exposure of the complementary alignment attributes is shifted in a desired direction such that the exposure of the array of complementary alignment attributes overlays the exposure of the array of alignment attributes and the exposure of complementary alignment attributes is performed at a second focus position, then measuring the exposed attributes and complementary attributes; and determining the telecentricity of the exit pupil of the projection imaging tool based upon the measurements.

An embodiment of determining telecentricity of a source in a projection imaging tool can include exposing an array of alignment attributes onto a substrate, wherein the exposure of alignment attributes is performed at a first focus position, then exposing an array of complementary alignment attributes onto the substrate, wherein the exposure of the complementary alignment attributes is shifted in a desired direction such that the exposure of the array of complementary alignment attributes overlays the exposure of the array of alignment attributes and the exposure of complementary alignment attributes is performed at a second focus position, then measuring the exposed attributes and complementary attributes; and determining the telecentricity of the source of the projection imaging tool based upon the measurements.

### BRIEF DESCRIPTION OF THE DRAWINGS

FIG. 1 shows a block diagram of the projection imaging tool.

FIG. 2 shows definitions of non-telecentricity.

FIG. 3 shows a process for measurement of exit pupil telecentricity, first embodiment.

FIG. 4a shows a sample 12×14 encoded face of dark field reticle.

FIG. 4b shows additional detail of overlay group (OLG) of EF and inner and outer boxes.

FIG. 5 shows a sample 3×2 printed array of overlaid inner and outer boxes.

FIG. 6 depicts simulations showing behavior of an 85% annular source on the differential shift coefficients for binary targets as a function of sigma.

FIG. 7 shows a process for reconstruction of exit pupil telecentricity given aberration information.

FIG. 8 shows exemplary results for the first embodiment ne telecentricity by field position.

FIG. 9 shows a second embodiment process for determination of exit pupil telecentricity.

FIG. 10 shows an integral diffuser, D, on reticle backside, RB, for the purpose of creating an effective source with σ>σ_{critical}.

FIG. 11 shows an exemplary diffuser output angular spectrum.

FIG. 12 shows a third embodiment process for determination of exit pupil telecentricity.

FIG. 13 shows a fourth embodiment of a process for measuring source and exit pupil telecentricity.

FIG. 14 shows overlay groups for the fourth embodiment with sections A-A and B-B.

FIG. 15 shows the binary mask cross-section through AA of FIG. 14.

FIG. 16 shows the 180 degree phase-shift section BB of FIG. 14.

FIG. 17a shows the OLG overlay targets on the reticle.

FIG. 17b shows the printed group at wafer level.

FIG. 18a shows a sample response curves of binary section AA (FIG. 14).

FIG. 18b shows a sample response curves for phase-shift section BB (FIG. 14).

FIG. 19 shows a process flow for a fifth embodiment for measuring source telecentricity.

FIG. 20 shows a sixth embodiment of a process for measuring source and exit pupil telecentricity.

FIG. 21 shows a cross section of a reticle in the sixth embodiment; z-mapping.

FIG. 22 shows the plan view of overlay group field point layout, spacing at reticle.

FIG. 23 shows the numbering for bar structures in OLG FIG. 22.

FIG. 24 shows reticle specifications for the Z-structures labeled 1:5 in FIG. 23.

FIG. 25 shows reticle specifications for the telecentricity structures labeled 6-12 in FIG. 23.

FIG. 26 shows a view of the reticle backside as used in a sixth embodiment.

FIG. 27 shows an outer box Z-mapping structure ZO.

FIG. 28 shows a schematic of the same printed overlay group (OLG1) at focus settings Z1 and Z2 at conclusion of Block 18 of the sixth embodiment.

FIG. 29 shows a schematic of the same printed overlay group (OLG1) at focus settings Z1 and Z2 and outer box structure ZO.

FIG. 30 shows a sample inner box (IB) and outer box (OB) printed on wafer.

### DETAILED DESCRIPTION OF THE INVENTION

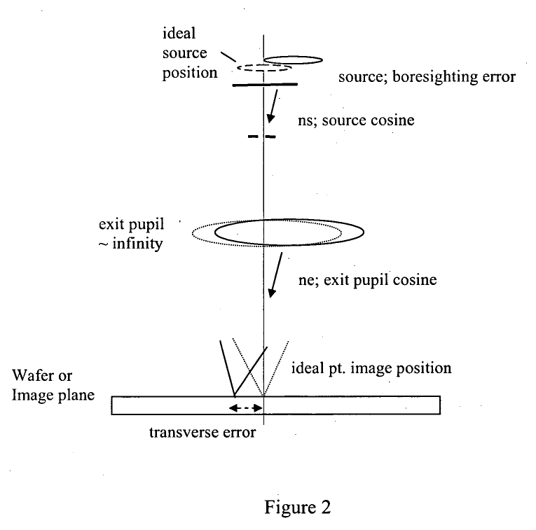

As discussed above, the drive towards low k1 semiconductor manufacturing has continuously placed greater emphasis on reducing layer-to-layer pattern misalignment. The need to implement fast, accurate, and precise overlay monitoring and correction methodologies is now critical for the semiconductor industry and will continue to be vital for semiconductor manufacturers as overlay error specifications approach a few tens of nanometers (see, for example, “International Technology Roadmap for Semiconductors, 2001 Edition, Lithography”, ITRS, 2001 Edition, pp. 1-17, 2001; and “Lithography Difficult Changes”, ITRS, 2002 Update, pp. 63-64, 2002). This patent describes a method and apparatus for determining exit pupil telecentricity and source boresighting error. FIG. 2 shows technical definitions. The exit pupil telecentricity and source boresighting error effects are coupled in terms of the positional shift they induce. Techniques are described for decoupling these effects. Several embodiments follow—including manufacturing opportunities. To this end, we now describe a method for measuring exit pupil telecentricity independent from source boresighting error. The first embodiment of the present invention measures exit pupil telecentricity exclusively while further embodiments describe additional possibilities. Aspects of techniques described make use of a different set of auxiliary focus structures as described in the co-pending application “Simultaneous Determination of Focus and Telecentricity”, A. Smith, et. al. In the prior art cited above (Brunner), each phase-shifting focus monitor (site by site across the field) requires calibration with a CD SEM (scanning electron microscope) and optical microscope. We make use of the monitors disclosed by Smith since they do not require a lengthy calibration procedure and are more easily implemented in production environments.

FIG. 2 shows an illustration that will be useful for our work here since it contains definitions for this discussion.

### First Embodiment

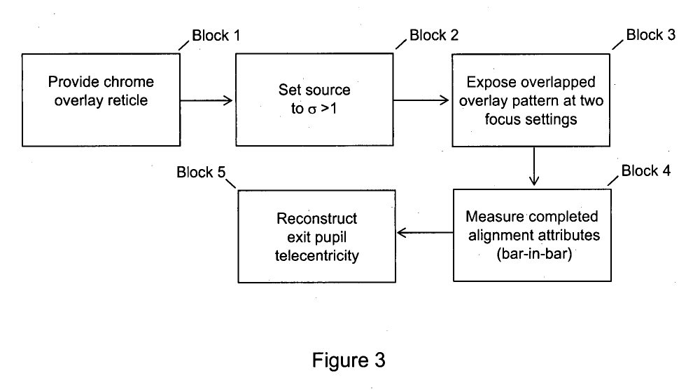

FIG. 3 shows a block diagram (Blocks 1-5) for a process used in a first embodiment.

Block 1: Provide Chrome Overlay Reticle

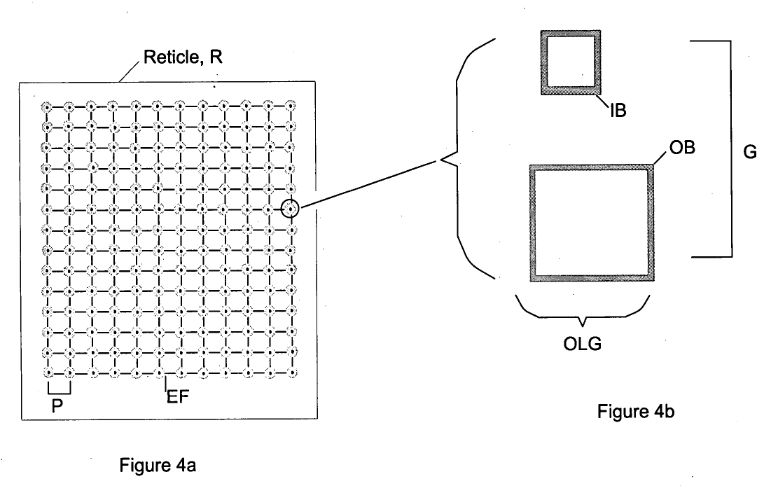

A chrome overlay reticle, or mask, is provided. FIG. 4a shows a sample of an encoded dark field reticle face with a 12×14 array of overlay groups (OLG). FIG. 4b shows a close-up of single overlay group (OLG) which in this case consists of an outer bar pattern (OB) slightly (<0.5 mm on reticle) offset from inner bar pattern (IB). OB and IB are complementary alignment attributes (bar-in-bar and box-in-box) as discussed in the open literature (see, for example, Sullivan, “Semiconductor Pattern Overlay”, Proc. of SPIE, Vol. CR52, pp. 160-188).

In one embodiment, a mask for determining telecentricity of an exit pupil in a projection imaging tool includes an array of patterns, each pattern having at least a first feature, a second feature, a third feature, and a fourth feature, wherein the first and second features are binary and at least a portion of the third and fourth are phase-shifting. In another embodiment, a mask for determining telecentricity of an exit pupil in a projection imaging tool includes an array of patterns, each pattern having at least a first feature and at least a second feature wherein the first and second features are binary or phase-shifting. In addition, the first and second features may be aligned to a diffusing element located on a surface of a reticle. In still another embodiment, a mask for determining a source telecentricity in a projection imaging tool includes an array of patterns, each pattern having at least a first feature, a second feature, a third feature, and a fourth feature, wherein the first and second features are binary and at least a portion of the third and fourth features are phase-shifting.

Block 2: Set the Effective Source

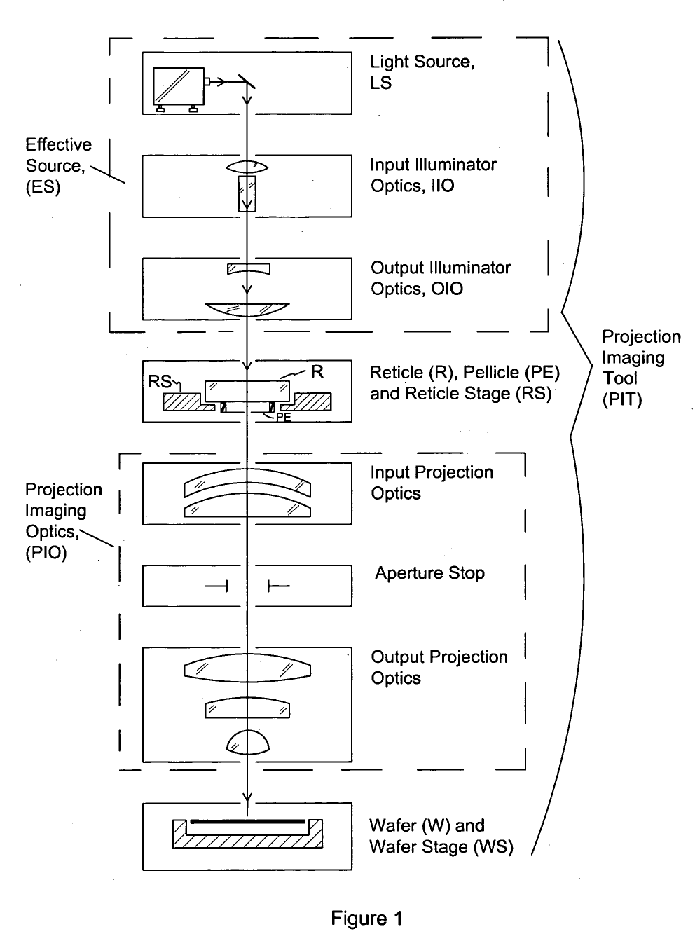

FIG. 1 shows a block diagram of a projection imaging tool or PIT. For the first embodiment, we set the effective source, ES, to a condition that will overfill the entrance pupil (i.e., sigma=σ>1). This may require modification of effective source diffuser in effective source beam train to produce a σ>1 source; σ>1.2 is desirable. Additionally, we could use integral σ>1 settings provided on the scanner tool. Integral scanner setting could include diffuser placed in the lithography tool source beam train between IIO and OIO or other suitable location (see FIG. 1), to produce a σ>1 effective source. For instance, a diffuser placed at appropriate conjugate plane in ES (FIG. 1) will produce the desired effect.

Block 3: Print OLGs

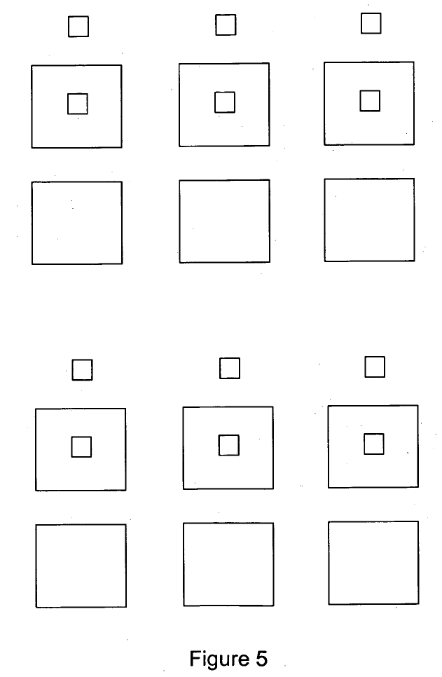

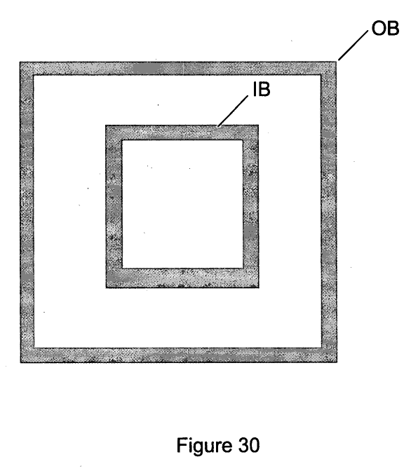

First, the binary, chrome mask with arrays of outer box patterns (see OB, FIGS. 4a and 4b) is printed at wafer standard nominal height Z1˜+500 nm towards lens (positive) from best focus position. Next, the inner box array (see IB, FIGS. 4a and 4b) is printed at nominal height Z2 (˜−500 nm); where the inner and outer box are printed at the same lens field location (hence requiring a reticle positional shift between exposures—FIG. 4b). Alternately, the Wafer could be shifted an amount G/M (M=reduction magnification ratio which is typically 4 or 5) and we rely on the spatial slowness of the telecentricity variation (isoplanatic patch) to not produce an appreciable change in lens telecentricity over this interval. The result of these exposures is shown in FIGS. 30 and 5.

Block 4: Measure Alignment Attributes

Following printing (or exposure using an electronic array) the box (bar) shift for the alignment attributes is measured on a conventional overlay reader (see, for example, “KLA 5200 Overlay Brochure”, supra). The result is:
(BBX,BBY)(ix=1:NX,iy=1:NY) (Equation 1)
Block 5: Remove Stage Error

Since the wafer and reticle stages introduce both translational and rotational overlay errors the effects must be removed for the entire Nx by Ny box-in-box (bar-in-bar) measurement set. The result is reduced measurement set.
(BBX^{r},BBY^{r})(ix=1:Nx,iy=1:Ny) (Equation 2)

Next we compute \overline{n}e or the direction cosine for telecentricity as:

$$\overline{n} e ( ix , iy ) = \begin{matrix}( {BBX}^{r} , {BBY}^{r} ) \\ ( ix , iy )\end{matrix} / [ ( Z 2 - Z 1 ) * \frac{{ⅆ}^{2} x}{ⅆ zdne} ] \qquad ( Equation 3 )$$

Where

$$\frac{{ⅆ}^{2} x}{ⅆ zdne} ∼ - 1$$

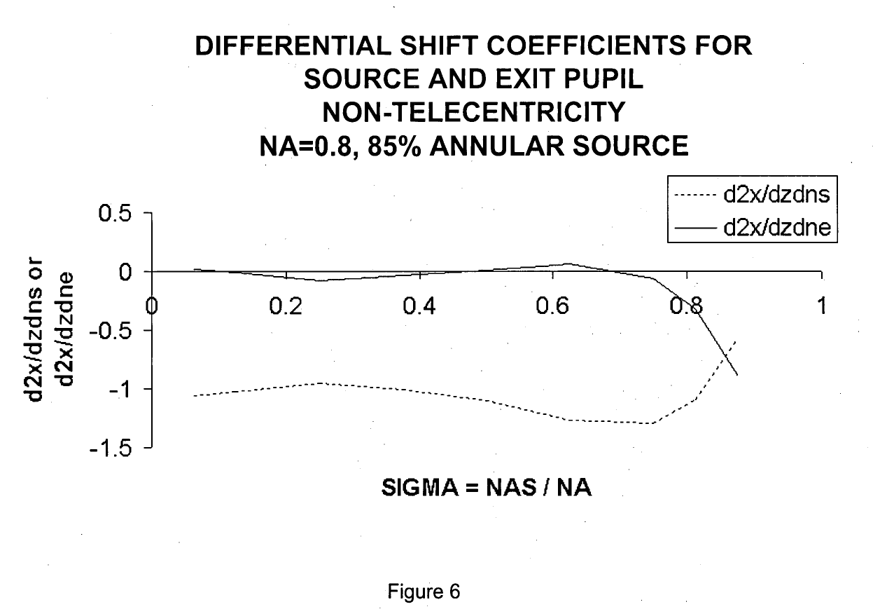

but is simulated (see below for additional information), for example, using a lithographic simulation engine, see FIG. 6 for example sensitivities.

The techniques described work since a large uniform source (sigma>the exit pupil) has minimal impact on net ray angles incident on the wafer (this can be shown in using a lithographic simulator if not intuitively; σ>>1 corresponds to the incoherent imaging limit as opposed to the partially coherent imaging situation normal to semiconductor manufacturing). In simulating pattern feature shift or the differential shift coefficients (FIG. 6) we utilize the specific mask geometry of our alignment attributes and the nominal source (sigma>1, conventional) and exit pupil (NA=nominal NA, flat-top transmission) profiles.

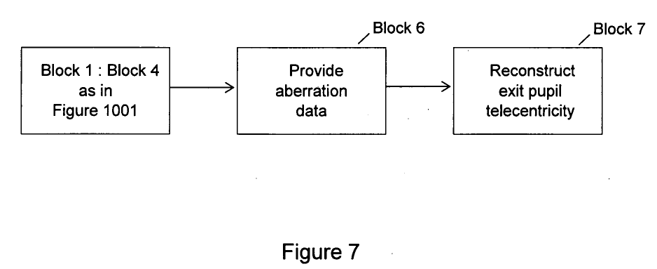

Further Refinement: Blocks 6-7 FIG. 7

FIG. 7 shows a further refinement in the process for determining exit pupil telecentricity when aberration or phase information is available. See, for example, Smith et al., “Apparatus, Method of Measurement, and Method of Data Analysis for Correction of Optical System”, U.S. Pat. No. 5,828,455, Oct. 27, 1998 and Smith et al., “Apparatus Method of Measurement and Method of Data Analysis for Correction of Optical System”, U.S. Pat. No. 5,978,085, Nov. 2, 1999, provide details for determining lens aberrations for modern photolithographic exposure tools such as scanners and steppers (248 nm and 193 nm for example). When the lens aberration data is known, we can now write the reduced overlay box shift (BBX^{r}, BBY^{r}) in Equation 2 as:

$$\begin{matrix}{BBX}^{r} = ( Z 2 - Z 1 ) \frac{{ⅆ}^{2} x}{ⅆ zdne} + {\sum }_{j = 1}^{NZ} Δ {BBX}^{r} \\ ( Z 2 , {a}_{j} ) - Δ {BBX}^{r} ( Z 1 , {a}_{j} )\end{matrix} \qquad ( Equation 4 )$$

and similarly for BBYr

where;

aⱼ=measured zernike coefficient; j=1: NZ

ΔBBXr (Zi, aⱼ)=simulated contribution of aberration aj to box shift at focus Zi. Since the second (sum) term is known, it can be corrected for in the final output.

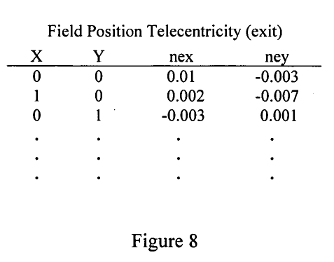

An example of the final result of this method is shown in FIG. 8 where we have telecentricity divorced from source influence as a function of field position.

Further Arrangements:

### Second Embodiment

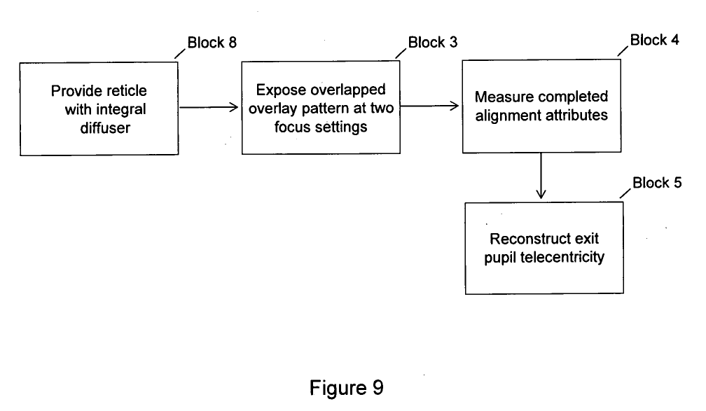

We now describe a method and apparatus for measurement of exit pupil telecentricity (divorced from the source boresighting error) using a reticle and diffuser. Refer to FIG. 9 for designation and description of the various blocks.

Block 8: Provide Reticle and Diffuser

Provide reticle with local diffuser on back side of reticle. The purpose is to provide a source with a sigma=σc>1. Where, ac is the critical sigma value where the contribution of the source to the box-in-box shift can be ignored, e.g.,

$$\vert \frac{{ⅆ}^{2} x}{ⅆ {zdn}_{s}} \vert 〈 〈 \vert \frac{{ⅆ}^{2} x}{ⅆ zdne} \vert \cdot \qquad ( Equation 5 )$$

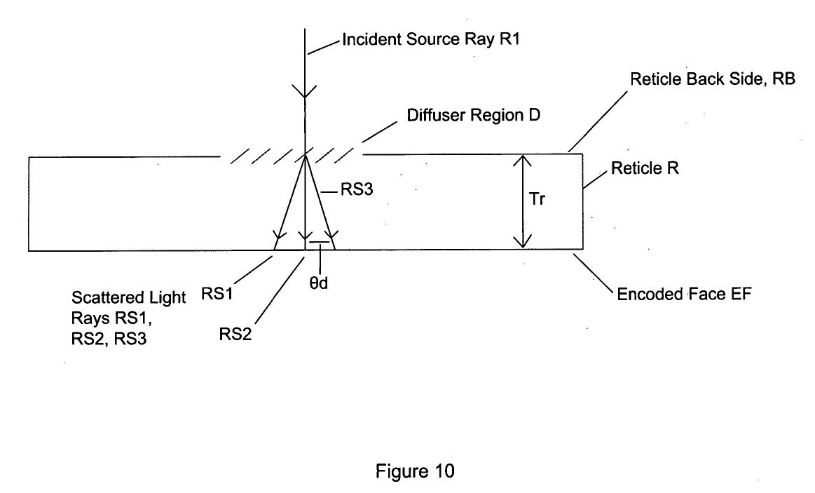

To create this source setting we place or locate diffuser, D, (FIG. 10) on the reticle backside, RB (second surface). The diffuser, D, has an angular half-width/half angle (θd FIG. 10) big enough to spread out an incident source width σ<σ_{c} to one with σeff≧σ_{c}. The effective source sigma of the combined diffuser/stepper source is

$$σ eff = σ + \frac{M}{2} \frac{NA d}{NA}$$

where NAd=sin(θd).
Since σeff≧σ_{c} we need for NAd:

$$NA d \geq 2 ( {σ}_{c} - σ ) \frac{NA}{M} .$$

For example, consider the following process parameters:
NA=0.8, M=4, scanner, σ_{c}=1.2, σₘₐₓ=0.8=maximum available sigma setting for the machine of interest. Then the diffuser NAd would be:

$$NA d \geq 2 ( 1.2 - 0.8 ) \frac{0.8}{4} = 0.16$$

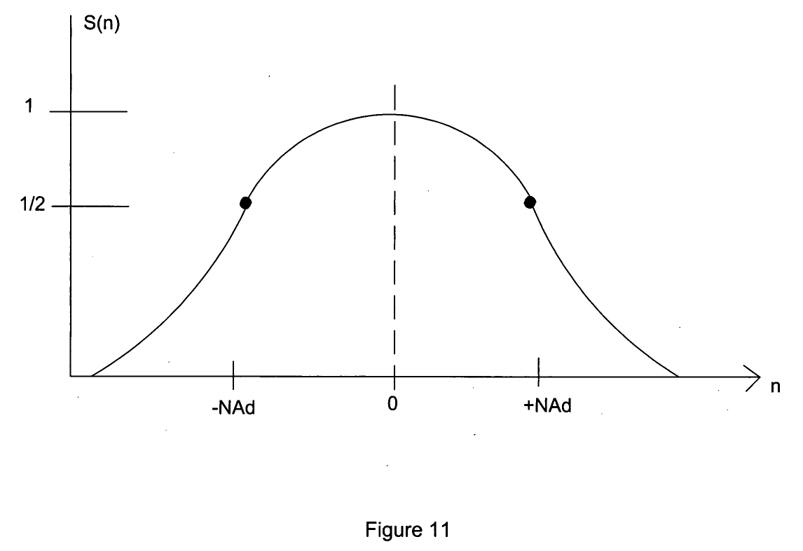

or the diffuser half-angle≧9.2°. This amount of diffusion is easily obtained for standard diffusers—this calculation illustrates the feasibility. A more detailed analysis involves considering the precise diffuser output spectrum (an exemplary spectrum is shown in FIG. 11). Here we can convolve the angular output spectrum for the diffuser with the input source and then simulate the result to compute

$$\frac{{ⅆ}^{2} x}{ⅆ zdne}$$

and

$$\frac{{ⅆ}^{2} x}{ⅆ zdns}$$

as a function of NAd to and thereby determine when Equation 5 (above) holds; where ns defines the source direction cosine telecentricity (FIG. 2).
Blocks 3, 4 and 5: Expose, Measure, Reconstruct

Having provided an appropriate diffuser matched to a particular source size, the further steps are the same as in Embodiment 1 as shown in FIG. 9.

### Third Embodiment

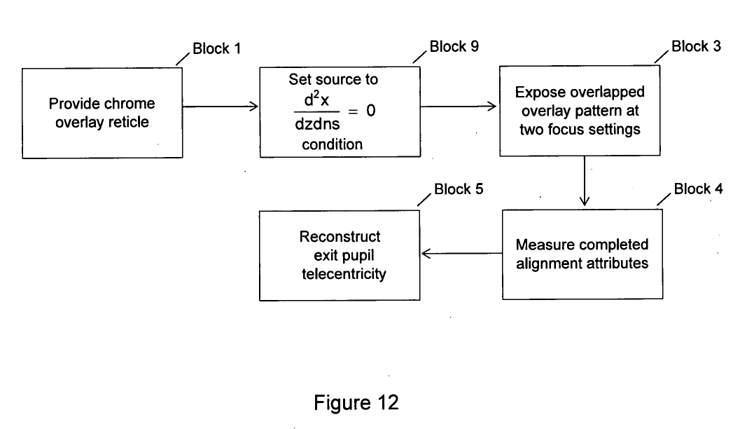

For this additional embodiment we present a method for measuring exit pupil telecentricity independent from source boresighting error. A flowchart of this embodiment is shown in FIG. 12 where Blocks 1, 3, 4, and 5 are as described in the first embodiment.

Block 9: Set Source Sigma

The user provides effective source (ES) that is insensitive to source telecentricity on our particular pattern. That is:

$$\frac{{ⅆ}^{2} x}{ⅆ zdns} ≅ 0 \qquad ( Equation 6 )$$

Some Exemplary Conditions for this Source Setting are:

TABLE 1

| M | λ | NA | NAₛ | NAₒ | ${σ}_{s} = \frac{{NA}_{s}}{NA}$ | $\frac{{NA}_{o}}{{NA}_{s}}$ | $\frac{{d}^{2} x}{{dzdn}_{s}}$ | $\frac{{d}^{2} x}{dzdne}$ |
|---|---|---|---|---|---|---|---|---|
| 5 | 365 | 0.6 | 0.574 | 0.385 | 0.957 | 0.670 | 0.002 | −1.102 |
| 4 | 248 | 0.8 | 0.791 | 0.530 | 0.988 | 0.670 | −0.005 | −1.468 |
| 4 | 248 | 0.8 | 0.719 | 0.482 | 0.899 | 0.850 | −0.006 | −1.650 |

Values in Table 1 are determined by lithographic simulation similar to those described above and shown in FIG. 6. The outer annular sigma while large (˜0.9), is still feasible on modern lithographic machines.
Blocks 3, 4, and 5: Print, Measure, and Reconstruct Exit Pupil Telecentricity

The process for these blocks is the same as that for the first embodiment.

### Fourth Embodiment

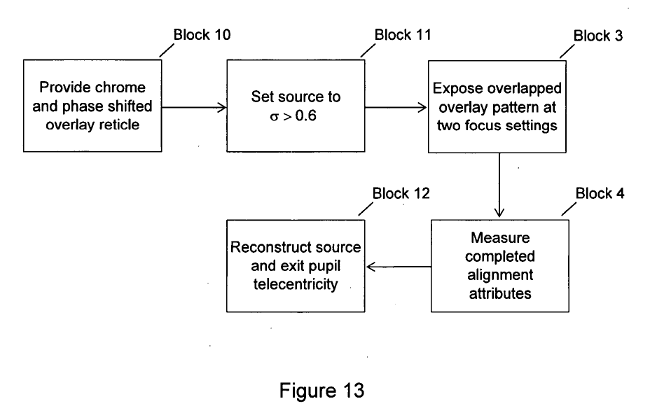

For a fourth embodiment we introduce a method for the simultaneous determination of both source (ns) and exit pupil telecentricity (ne) as defined above. For practical applications we provide arrangements that work over a wide range of source configurations. Since source boresighting error (ns) changes with source sigma setting, we fix the source setting—thus providing for the simplest determination scheme. FIG. 13 shows the flowchart for this embodiment. Blocks 3 and 4 are as in the first embodiment, except where noted below.

Block 10: Provide Phase-Shift Reticle

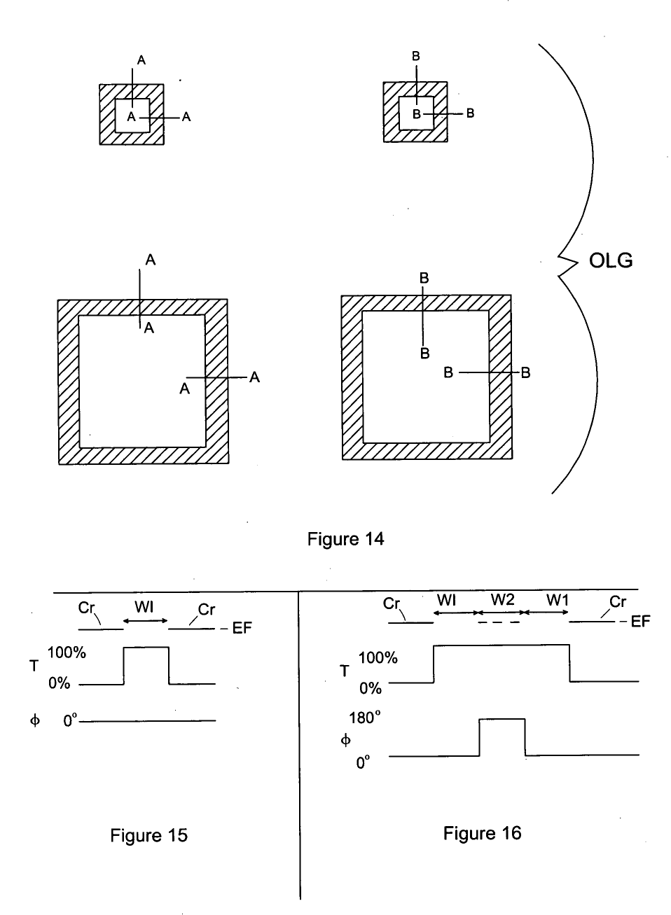

A reticle as shown in FIG. 14, similar to that described in FIGS. 4a and 4b is first provided. Here however, the OLG group is augmented by adding a phase-shifted complementary pair of alignment attributes as shown in FIG. 14. This new OLG group now includes four parts—two complete sets of alignment attributes—where one pair is binary (chrome) and the other pair is phase-shifted (sections AA cut binary features and BB cuts phase-shifted features in FIG. 14). In practice, the width of the outer and inner alignment attributes for both sets of alignment attributes (binary and psm) print at ˜1 um at the wafer but the complexity of the mask feature dimensions, phases, and transmission functions are different (see section AA in FIG. 15 and section BB in FIG. 16 for typical examples of both binary and psm mask cross-sections and physical attributes).

Block 11: Select Illumination Condition

Next a convenient illumination source with sigma >0.6 is selected for exposure. Since the phase-shifted alignment attributes are known to be imaged differently thru-focus as compared with binary features, the binary and phase-shifted boxes will have different telecentric responses.

Block 3: See the First Embodiment Block 3

Block 4: Measure Alignment Attributes (both sets)

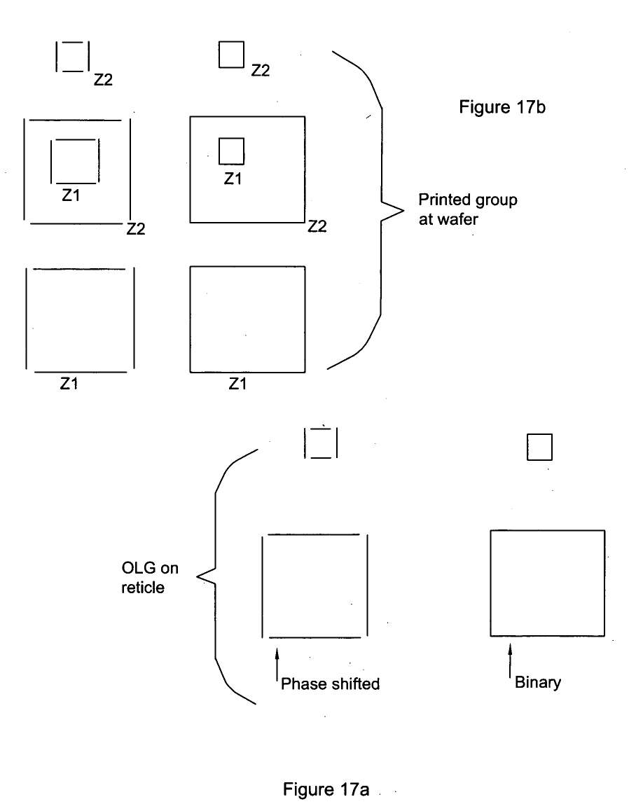

The number of alignment attributes to measure now consists of two box-in-box measurements per OLG (see FIG. 17a).

Block 12: Reconstruct Dual Telecentricities

For the overlapped phase-shifted structure in FIGS. 17a and 17b the outer box (BBO), inner box (BBI) and combined responses (BBC) are:
BBO=(Aₚnₛ+Bₚnₑ)(Z2−ZW)
BBI=(Aₚnₛ+Bₚn_{c})(Z1−ZW)
BBC=BBI−BBO=(Aₚnₛ+Bₚnₑ)(Z1−Z2) (Equation 7)
while for the binary alignment attributes (BBO′, BBI′, and BBC′) we have:
BBC′=(A_{b}nₛ+Bₚnₑ)(Z1−Z2) (Equation 8)

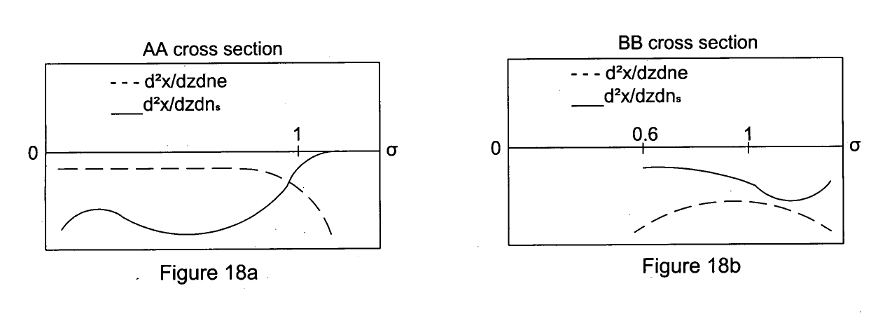

Since Ap Bp, Ab, Bb are known and reasonably orthogonal from both theory and simulation (FIGS. 18a and 18b)—and the focus (ZW) drops out, we can solve for \overline{n}e and \overline{n}s (telecentricities) via Equation 9:
Aₚnₛ+Bₚnₑ=BBC/(Z1−Z2)
A_{b}nₛ+Bₚnₑ=BBC′/(Z1−Z2) (Equation 9)

### Fifth Embodiment

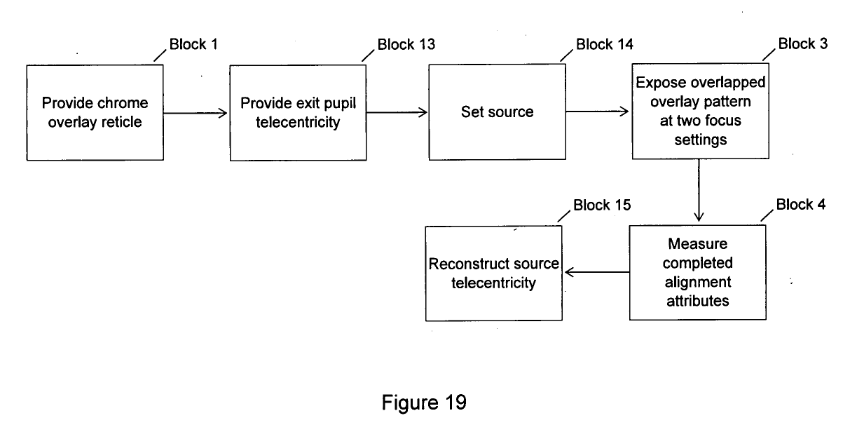

For a fifth embodiment we present a method for measuring source (non) telecentricity. Refer to FIG. 19 for the process using Blocks 1, 13, 14, 3, 4, and 15. Block 1 is same as in the first embodiment (providing the reticle). For this embodiment we focus our attention on the fact that given the exit pupil telecentricity we can go ahead and solve for source telecentricity.

Block 13: Provide Exit Pupil Telecentricity

Using any of the preferred methods or through rigorous lens design plans the user supplies proper estimates for exit pupil telecentricity (typical values are <30 milliradians).

Block 14: Set Source Sigma

User sets source to be measured (typical sigma ˜0.6).

Blocks 3 and 4:

Same as in the first embodiment, the targets are exposed/printed and measured.

Block 15: Reconstruct Source Telecentricity

(BBX^{r}, BBY^{r})=stage mode reduced box-in-box measurement as discussed above in the first embodiment.

$$= ( \frac{{ⅆ}^{2} x}{ⅆ {zdn}_{e}} {n}_{e} + \frac{{ⅆ}^{2} x}{ⅆ {zdn}_{s}} ns ) ( Z2 - Z1 ) \qquad ( Equation 10 )$$

The only unknown in Equation 10 is the source non-telecentricity, so we get:

$$\overline{ns} = \frac{( {BBX}^{r} , {BBY}^{r} )}{( Z2 - Z1 ) ( {d}^{2} x / dzdns )} - \frac{{ⅆ}^{2} x / dzdne}{{ⅆ}^{2} x / {dzdn}_{s}} \overline{{n}_{e}} \qquad ( Equation 11 )$$

### Sixth Embodiment

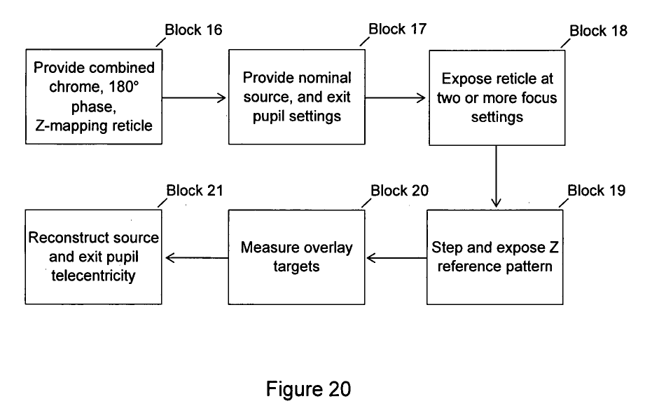

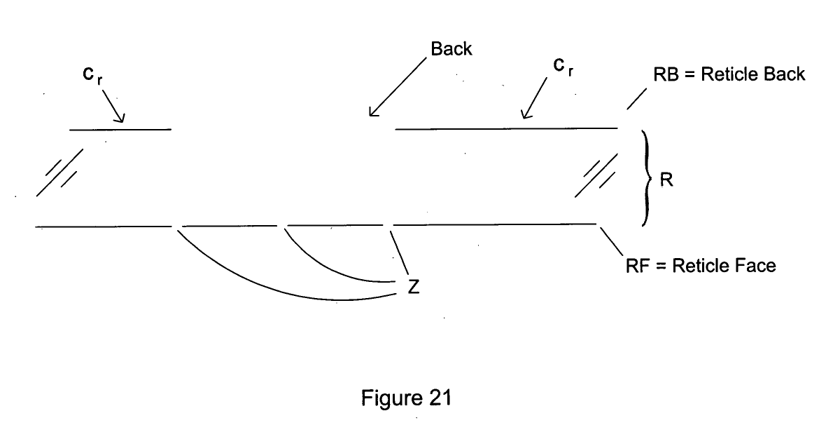

In another embodiment, we reconstruct both source telecentricity and exit pupil telecentricity using a 2-part mask or reticle design to fully account for unknown focusing errors. Where the first part of the mask comprises a complementary set of phase-grating alignment attributes (bar-in-bar) and the second part of the reticle comprises Z-map test structures. FIG. 20 shows an overview of this embodiment in block format (Blocks 16-21). FIGS. 21-25 show the details of the complex reticle.

Block 16: Provide Combined Reticle

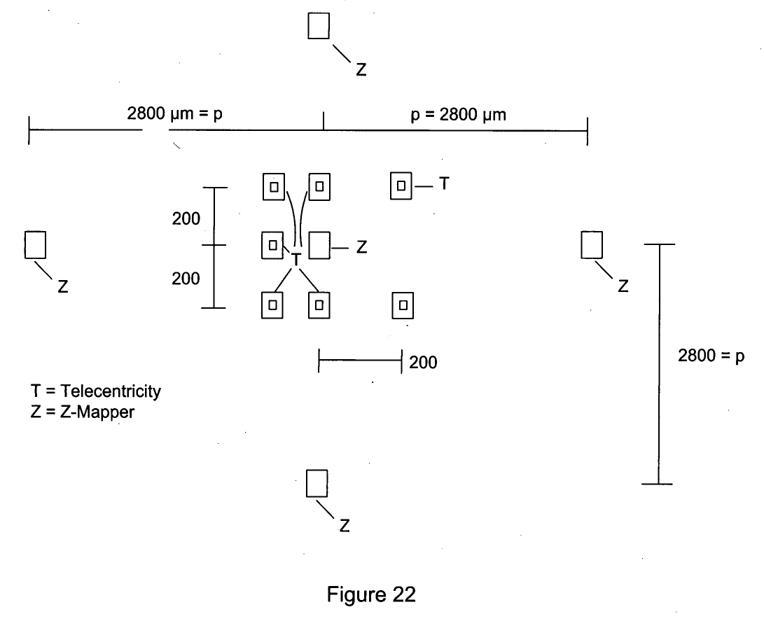

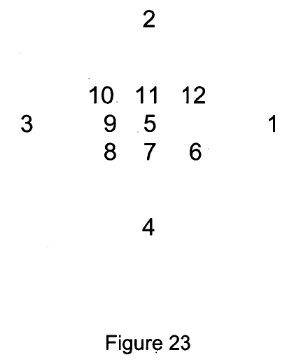

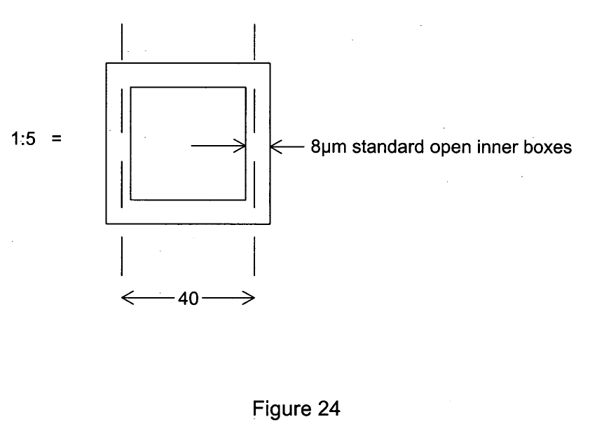

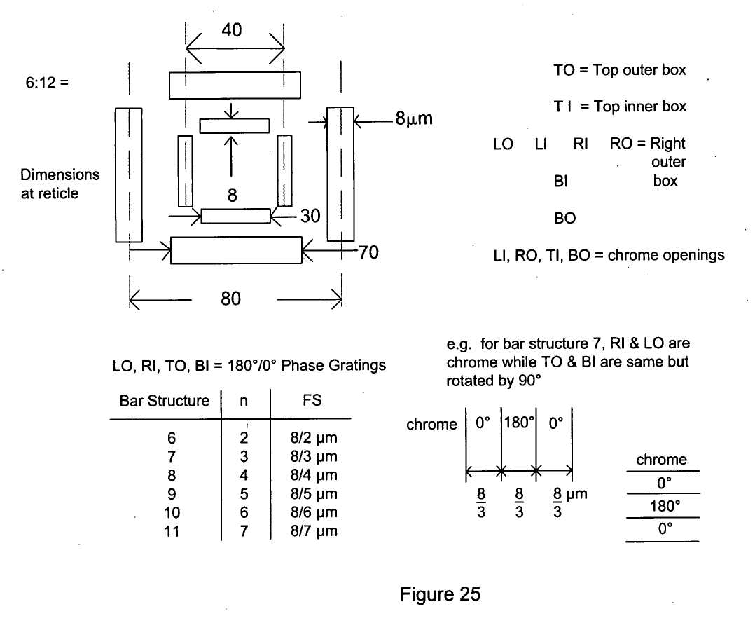

FIGS. 21-25 show the details of the combination reticle. We note that unlike the previous embodiments we now will be able to measure the exact wafer height or focus position of the wafer using a focus structure. This is aimed at the understanding that there many sources of focusing error (wafer non-flatness, interferometer calibration, optical aberrations, and other scanning issues). A reticle cross-section showing the focus structures used for this embodiment are shown in FIG. 21. Here, the back of the reticle (second surface) includes small openings that only allows source light from half the source (the details of the structures are described in co-pending application “Simultaneous Determination of Focus and Telecentricity”, supra. The Z-map or focus structures are used to determine the absolute state of focus of the wafer plane using overlay methods and a singular value decomposition technique. For the present embodiment the Z-structures are arranged along with the telecentricity overlay patterns (T) described earlier (see FIG. 22 Z and T structures). A typical OLG will now include two types of patterns, psm-grating alignment attributes with different grating pitches (T), and focus-structures (Z) arranged spared ˜3000 μm from the pattern center. A plan view of a typical OLG group is shown in FIG. 22, while a numerical assignment for each feature type is given in FIG. 23. The detailed reticle structure of each alignment attribute type is given in FIGS. 24 and 25.

Thus features one (1) through five (5) are 40 micron square tori 8 microns thick while features six (6) through twelve (12) are each bar tori structures with 180° phase shift structures modulating some of the horizontal and vertical bars. As illustrated in FIG. 25 each of features six (6) through twelve (12) are completed bar-in-bar alignment attributes and on each one the left inner (LI), right outer (RO), top inner (TI), and bottom outer (BO) bars are simple chrome openings 8 μm wide. The other four segments making up the bar-in-bar pattern (left outer, (LO), right inner (R1), top outer (TO), bottom inner (BI)) are clear 8 μm wide structures consisting of alternating 0° and 180° phase shift segments. For example, and as illustrated in FIG. 25, the alternating phase shift structures in bar structure number 7 consist of a 0° phase shift region 8/3 μm wide, followed by a 180° phase shift region and then a 0° phase shift region all of the same width.

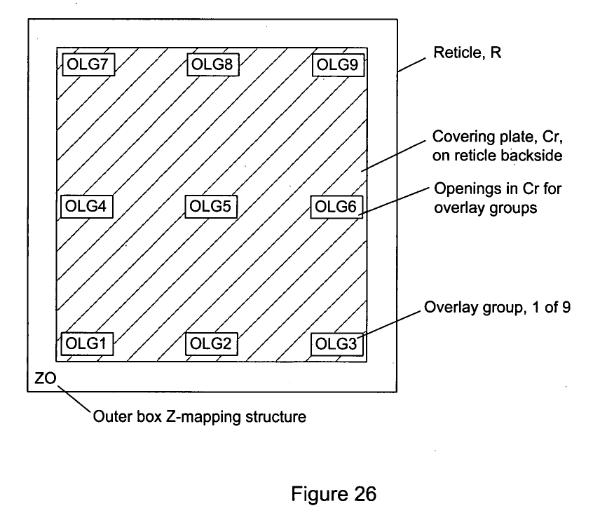

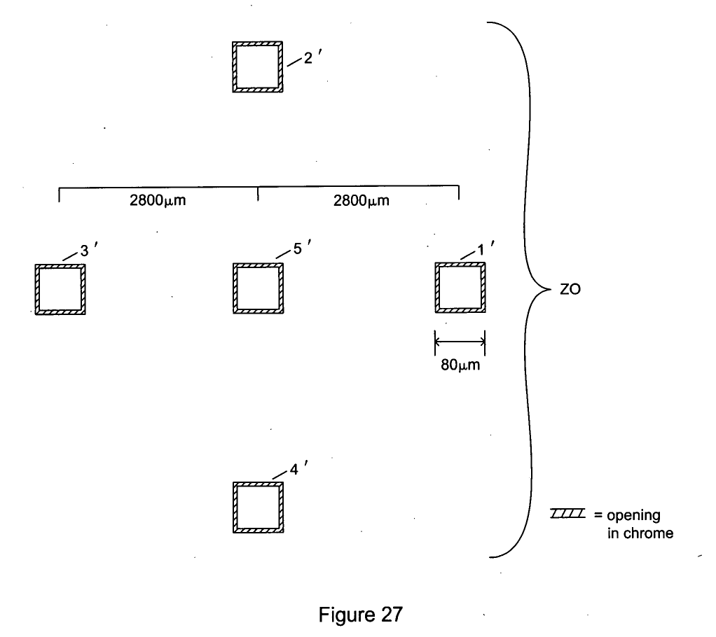

FIG. 26 provides a view of the back side of reticle R showing the covering plate, Cr, that has 5.6×5.6 mm² openings centered over each overlay group (9 shown, OLG1:OLG9) and outer box Z-mapping structure, ZO. ZO is shown in more detail in FIG. 27 and it consists of a group of five outer bar patterns with the indicated dimensions at the reticle. Covering plate Cr (which is located on the reticle backside) in no way obstructs or occludes light from effective source ES that reaches the chrome openings of ZO. So as a practical matter, no point on Cr is transversely within 1.5 mm of said openings.

Block 17: Provide Nominal Source Settings (for example, sigma 0.6, exit pupil NA=0.7)

Block 18: Expose Reticle (2 Focus Settings Minimal)

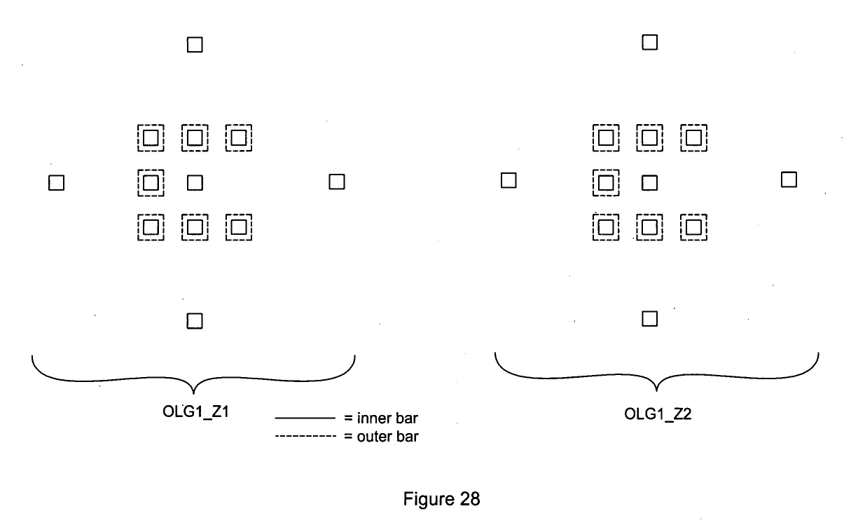

We now expose the overlay groups (OLG1:OLG9 of FIG. 26) at two focus settings Z1 and Z2. Typically |Z2−Z1|˜1 μm and FIG. 28 shows overlay group OLG1 as printed on the wafer at the two focus settings. Note that only the ‘T’ structures which have 0° and 180° phase shifters are printed at this stage as completed alignment attributes (bar-in-bar patterns).

Block 19: Step and Expose Z-structures

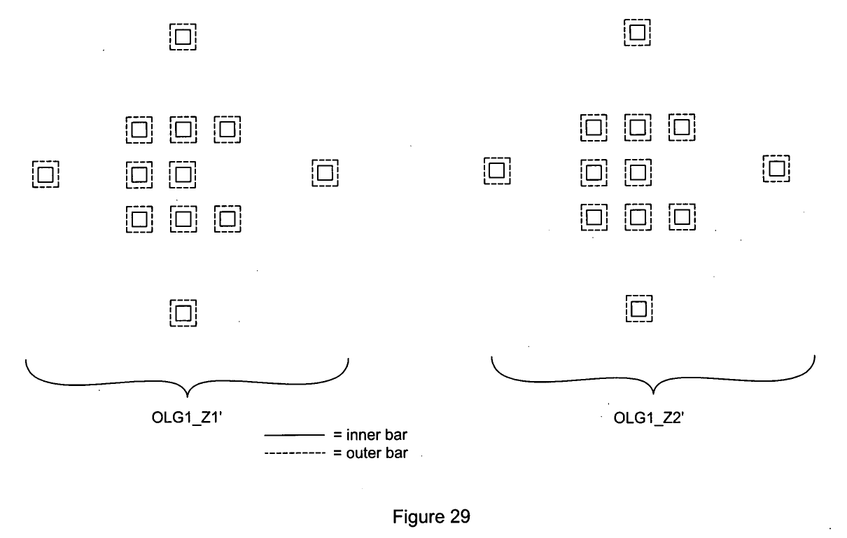

We now step the outer box Z-mapping structure, (ZO of FIG. 27) at nominal zero focus around to each printed overlay group laid down in the previous step. Examples of the resulting printed structure are shown in FIG. 29. Note that as a result of this step, the five incomplete alignment attributes (bare inner boxes) in OLG1_Z1, FIG. 28 are now completed, OLG1_Z1′ of FIG. 29.

Block 20: Measure Overlay Targets

Following exposure we measure both the completed telecentricity phase-grating targets T and focus-structures Z. FIG. 29 shows the as-printed overlay structures for measurement corresponding to a single overlay group, OLG.

Block 21: Reconstruct Source and Exit Pupil Telecentricity

Now, since the response for each telecentricity phase-grating is simulated (that is, we know the sensitivities

$$\frac{{ⅆ}^{2} x}{ⅆ zdns}$$

and

$$\frac{{ⅆ}^{2} x}{ⅆ zdne}$$

see FIGS. 18a and 18b for example) we can then form the following bar-in-bar shift equations for each site (OLG):

$${{\frac{{ⅆ}^{2} BBX}{ⅆ zdnsx} \vert}_{i} , \frac{{ⅆ}^{2} BBX}{ⅆ zdnex} \vert}_{i} nex = \begin{matrix}( {BBX1}_{i} - {BBX2}_{i} ) / \\ ( {Z1}_{m} - {Z2}_{m} )\end{matrix} \qquad ( Equation 12 )$$

where:

$${{\frac{{ⅆ}^{2} BBX}{ⅆ zdnsx} \vert}_{i} , \frac{{ⅆ}^{2} BBX}{ⅆ zdnex} \vert}_{i} = \begin{matrix}\begin{matrix}computed differential shift coefficients \\ at phase shift structure \end{matrix} \\ \# i ( i = 6 \text{:} 12 )\end{matrix}$$

=computed differential shift coefficients at phase shift structure # i (i=6:12) nsx, nex=unknown source and exit pupil telecentricity
BBX1ᵢ, BBX2ᵢ=measured box-in-box structure for phase shift structure # i at focus Z1, Z2 respectively.
Z1ₘ, Z2ₘ=measured (by Z-mapping structures) focus values.
A similar equation holds for nsy, ney.
We have seven equations for two unknowns which we solve using least squares techniques.

In the embodiments described, the substrate that images are exposed on could be a semiconductor surface, a silicon wafer, a flat panel display, a reticle, a photolithographic mask, an electronic recording media, a CCD detector array, a CMOS detector, a diode array, or a liquid crystal material. The substrate can also include a recording media, such as a positive resist material or a negative resist material. In addition, the projection imaging tools described can be used with a photolithographic stepper, a photolithographic scanner, a direct write tool, an extreme ultra-violet photolithographic tool, or an x-ray imaging system. Also, in the embodiments described, the light source can have an annular cross-section.

The foregoing description and the illustrative embodiments of the present invention have been described in detail in varying modifications and alternate embodiments. It should be understood, however, that the foregoing description of the present invention is exemplary only, and that the scope of the present invention is to be limited only to the claims as interpreted in view of the prior art. Moreover, the invention illustratively disclosed herein may be practiced in the absence of any element which is not specifically disclosed herein.

We claim:

1. A method of determining telecentricity of an exit pupil in a projection imaging tool, the method comprising:
exposing an array of alignment attributes onto a substrate, wherein the exposure of alignment attributes is performed at a first focus position;
exposing an array of complementary alignment attributes onto the substrate, wherein the exposure of the complementary alignment attributes is shifted in a desired direction such that the exposure of the array of complementary alignment attributes overlays the exposure of the array of alignment attributes and the exposure of complementary alignment attributes is performed at a second focus position;
measuring the exposed attributes and complementary attributes; and
determining the telecentricity of the exit pupil of the projection imaging tool based upon the measurements.

2. The method as defined in claim 1, wherein shifting between exposures comprises shifting a reticle a desired direction.

3. The method as defined in claim 1, wherein shifting between exposures comprises shifting a wafer stage a desired direction.

4. The method as defined in claim 1, wherein exposing the alignment attributes and complementary alignment attributes occur within an isoplanatic patch of a lens in the projection imaging tool.

5. The method as defined in claim 1, wherein the exposures are performed with an effective light source configured to have a desired partial coherence.

6. The method as defined in claim 5, wherein the desired partial coherence is greater than or equal to 1.

7. The method as defined in claim 5, wherein the desired partial coherence is approximately 1.2.

8. The method as defined in claim 5, wherein the effective light source has an annular cross-section.

9. The method as defined in claim 1, wherein the substrate is a semiconductor surface, a silicon wafer, a flat panel display, a reticle, a photolithographic mask, an electronic recording media, a CCD detector array, a CMOS detector, a diode array, or a liquid crystal material.

10. The method as defined in claim 1, wherein the projection imaging tool is used with a photolithographic stepper, a photolithographic scanner, a direct write tool, an extreme ultra-violet photolithographic tool, or an x-ray imaging system.

11. The method as defined in claim 1, wherein the substrate further comprises a recording media.

12. The method as defined in claim 11, wherein the recording media is a positive resist material or a negative resist material.

13. The method as defined in claim 1, further comprising using knowledge of less aberration in determining the telecentricity of the exit pupil.

14. A method of determining telecentricity of an exit pupil in a projection imaging tool, the method comprising:
providing a source that is optically coupled to an optical imager having an exit pupil, wherein the source and the optical imager operate to produce an effective light source characterized by a partial coherence;
providing a reticle with an array of patterns, each pattern having at least a first feature and a second feature;
exposing the reticle to produce a first image of the array of patterns on a substrate;
exposing the reticle to produce a second image of the array of patterns on the substrate, wherein the first image was exposed with a first defocus and the second image was exposed with a second defocus that is different from the first defocus;
measuring positional offsets between features in the first image and features in the second image; and
determining the exit pupil telecentricity based on the positional offsets and an exit pupil differential shift coefficient.

15. The method as defined in claim 14, further comprising translating the reticle relative to the substrate after exposing the first image and before exposing the second image.

16. The method as defined in claim 14, wherein the features within the array of patterns are disposed with a constant pitch.

17. The method as defined in claim 14, wherein a differential shift coefficient of the exit pupil depends upon the effective light source partial coherence.

18. The method as defined in claim 17, wherein the exit pupil differential shift coefficient is approximately equal to −1.

19. The method as defined in claim 14, wherein the features comprise a first box and a second box.

20. The method as defined in claim 19, wherein a center of the first box is larger than the second box and the first box is disposed outside a perimeter of the second box.

21. The method as defined in claim 14, wherein the source is characterized by a source differential shift coefficient that is less than a differential shift coefficient of the exit pupil.

22. The method as defined in claim 21, wherein the source differential shift coefficient is approximately zero.

23. The method as defined in claim 21, wherein the exit pupil differential shift coefficient is greater than approximately 5 times the source differential shift coefficient.

24. The method as defined in claim 21, wherein the exit pupil differential shift coefficient is greater than approximately 10 times the source differential shift coefficient.

25. The method as defined in claim 14, wherein the effective source partial coherence is greater than or equal to a critical partial coherence.

26. The method as defined in claim 25, wherein the critical partial coherence is approximately 1.2.

27. The method as defined in claim 14, wherein the partial coherence is greater than or equal to 1.

28. The method as defined in claim 14, wherein the partial coherence is greater than or equal to 1.2.

29. The method as defined in claim 14, further comprising disposing a diffuser between the source and the reticle to produce an effective partial coherence that is greater than or equal to a critical partial coherence.

30. The method as defined in claim 14, wherein the source has an annular cross-section.

31. The method of claim 14, wherein a differential shift coefficient of the source is approximately zero.

32. The method as defined in claim 14, wherein at least one of the patterns further comprises a third feature and a fourth feature, wherein the third and fourth features are configured to produce a phase-shift.

33. The method as defined in claim 32, further comprising determining the exit pupil telecentricity based on a difference in positional offsets between the first and second features and positional offsets between the third and fourth features.

34. A method of determining telecentricity of a source in a projection imaging tool, the method comprising:
exposing an array of alignment attributes onto a substrate, wherein the exposure of alignment attributes is performed at a first focus position;
exposing an array of complementary alignment attributes onto the substrate, wherein the exposure of the complementary alignment attributes has been shifted in a desired direction such that the exposure of the array of complementary alignment attributes overlays the exposure of the array of alignment attributes and the exposure of complementary alignment attributes is performed at a second focus position;
measuring the exposed attributes and complementary attributes; and
determining the telecentricity of the source of the projection imaging tool based upon the measurements.

35. The method as defined in claim 34, wherein determining the telecentricity of the source includes processing data related to a telecentricity of an exit pupil.

36. The method as defined in claim 34, wherein determining the telecentricty of the source includes processing data related to a differential shift coefficient of an exit pupil.

37. The method as defined in claim 34, wherein determining the telecentricty of the source includes processing data related to a differential shift coefficient of the source.

38. A method of determining telecentricity of a source in a projection imaging tool, the method comprising:
providing the source that is optically coupled to an optical imager having an exit pupil, wherein the source and the optical imager operate to produce an effective light source characterized by a partial coherence;
providing a reticle with an array of patterns, each pattern having at least a first feature and a second feature;
exposing the reticle to produce a first image of the array of patterns on a substrate;
exposing the reticle to produce a second image of the array of patterns on the substrate, wherein the first image was exposed with a first defocus and the second image was exposed with a second defocus that is different from the first defocus;
measuring positional offsets between features in the first image and features in the second image; and
determining the source telecentricity based on the positional offsets.

39. The method as defined in claim 38, wherein determining the telecentricity of the source includes processing data related to a telecentricity of an exit pupil.

40. The method as defined in claim 38, wherein determining the telecentricty of the source includes processing data related to a differential shift coefficient of an exit pupil.

41. The method as defined in claim 38, wherein determining the telecentricty of the source includes processing data related to a differential shift coefficient of the source.

42. A method of determining a telecentricity of a source and an exit pupil in a projection imaging tool, the method comprising:
providing the source that is optically coupled to an optical imager having an exit pupil, the combination of the source and the optical imager characterized by a partial coherence;
providing a reticle with an array of patterns, each pattern having at least a first feature, a second feature, a third feature, and a fourth feature;
exposing the reticle to record at least a first image of the four features, the first image having a first defocus;
exposing the reticle to record at least a second image of the features, the second image having a second defocus;
exposing an outer box Z-mapping structures;
measuring positional offsets between recorded features; and
calculating the source and exit pupil telecentricity based on the positional offsets, an exit pupil differential shift coefficient, and a source differential shift coefficient.

43. A projection imaging tool system for determining telecentricity of an exit pupil, the projection imaging tool system comprising:
a source that is optically coupled to an optical imager having an exit pupil, the source and optical imager operate to produce an effective source characterized by a partial coherence;
a reticle having an array of patterns, each pattern having at least a first feature and a second feature;
a substrate for recording at least a first image and a second image of the features;
a positioner for disposing for adjusting the reticle relative to the substrate such that the first recorded image has a first defocus and the second recorded image has a second defocus different from the first defocus;
a stage for translating; and
a processor adapted for calculating the exit pupil telecentricity based on an exit pupil differential shift coefficient and positional offsets between features contained in the first image and features contained in the second image.

44. The system as defined in claim 43, wherein the patterns in the array of patterns are disposed with a constant pitch.

45. The system as defined in claim 43, wherein a sensitivity of the exit pupil differential shift coefficient is a function of the partial coherence.

46. The system as defined in claim 43, wherein the source is characterized by a source differential shift coefficient that is less than the exit pupil differential shift coefficient.

47. The system as defined in claim 43, wherein the partial coherence is greater than or equal to a critical partial coherence.

48. The system as defined in claim 47, wherein the critical partial coherence is approximately 1.2.

49. The system as defined in claim 47, wherein the critical partial coherence is greater than or equal to 1.

50. The system as defined in claim 43, wherein the partial coherence is greater than or equal to 1.2.

51. The system as defined in claim 43, further comprising a diffuser disposed between the source and the reticle for providing an effective partial coherence that is greater than or equal to a critical partial coherence.

52. The system as defined in claim 43, wherein the source has an annular cross-section.

53. The system as defined in claim 52, wherein the source differential shift coefficient is approximately zero.

54. The system as defined in claim 43, wherein at least one of the patterns further comprises a third feature and a fourth feature each able to produce a phase-shift.

55. A projection imaging tool system for determining source telecentricity, comprising:
a source that is optically coupled to an optical imager having an exit pupil, the combination of the source and the optical imager are characterized by a partial coherence;
a reticle having an array of patterns, each pattern having at least a first feature and a second feature;
a substrate for recording at least a first image and a second image of the features;
a positioner for disposing the first image and the second image such that the first image has a first defocus and the second image has a second defocus different from the first defocus;
a stage for translating; and
a processor for calculating the source telecentricity based on the exit pupil telecentricity, an exit pupil differential shift coefficient, a source differential shift coefficient, and positional offsets between features contained in the first image and features contained in the second image.

56. A mask for determining telecentricity of an exit pupil in a projection imaging tool, the mask comprising an array of patterns, each pattern having at least a first feature, a second feature, a third feature, and a fourth feature, wherein the first and second features are binary and at least a portion of the third and fourth are phase-shifting.

57. A mask for determining telecentricity of an exit pupil in a projection imaging tool, the mask comprising an array of patterns, each pattern having at least a first feature and at least a second feature wherein the first and second features are binary or phase-shifting.

58. The mask as defined in claim 56, wherein the first and second features are aligned to a diffusing element located on a surface of a reticle.

59. A mask for determining an exit pupil telecentricity in a projection imaging tool, the mask comprising an array of patterns, each pattern having at least a first feature, a second feature, a third feature, and a fourth feature, wherein the first and second features are binary and at least a portion of the third and fourth features are phase-shifting.

60. A projection imaging tool system for determining source telecentricity, comprising:
a source that is optically coupled to an optical imager having an exit pupil, the combination of the source and the optical imager are characterized by a partial coherence;
a reticle having an array of patterns, each pattern having at least a first feature and a second feature;
a substrate for recording at least a first image and a second image of the reticle features;
a positioner for disposing the substrate relative to the reticle such that the first image has a first defocus and the second image has a second defocus different from the first defocus; and
a processor for calculating source and exit pupil telecentricity based on positional offset measurements of features in the first and second images, a differential shift coefficient of the exit pupil, and a differential shift coefficient of the source.
